(19) United States
(12) Patent Application Publication
(10) Pub. No.: US 2022/0024831 A1
(43) Pub. Date: Jan. 27, 2022

(54) USE OF A BIOLOGICAL ADDITIVE INDUCING SOIL MICROBIOME FOR USE IN COMBINATION WITH MINERAL FERTILIZERS

(71) Applicant: Microbiol Indústria e Comércio Ltda, Limeira (BR)

(72) Inventor: Paulo Antônio D'ANDRÉA, Limeira (BR)

(73) Assignee: Microbiol Indústria e Comércio Ltda

(21) Appl. No.: 17/381,317

(22) Filed: Jul. 21, 2021

(30) Foreign Application Priority Data
Jul. 22, 2020 (BR) 10 2020 014928 8

(51) Int. Cl. C05F 11/08

(52) U.S. Cl. CPC C05F 11/08

(57) ABSTRACT

The present invention refers to the action of a biological additive, composed of an organic-mineral matrix, capable of being used together with mineral fertilizers, and inducing a greater activity of the soil microbiome. Said additive keeps the biochemical properties of the developed material stable when it is combined with mineral fertilizers, allowing the soil microbiome to be induced during the fertilizer application process, resulting in higher productivity. Another advantage is the fact that the biological additive can be used in small doses, and combined with different fertilizer formulations for use on all crops.

### FIELD OF INVENTION

The present invention relates to use and composition of a biological additive, composed of an organic-mineral matrix, capable of, when used in small quantities in combination with mineral fertilizers, inducing the activity of the soil microbiome and the rhizosphere of plants, in productive systems. The biological additive has biotechnological properties that allow its use combined with mineral fertilizers, which, in this case, makes possible, in an unprecedented way, the supply of mineral nutrients with the ability to induce the soil microbiome, which is defined as the set of microbial communities of complex interactions that include bacteria, fungi, archaea, protozoa, and viruses. The effect of using this technology can be gauged by enzymatic indicators of soil biological activity and its use results in increased productivity in agricultural systems.

### DESCRIPTION OF THE RELATED TECHNIQUE

The agricultural production capacity is determined by the chemical, physical and biological properties of the soils. The chemical properties of soils are well studied so that for the different agricultural crops the nutrient demands determined after soil chemical analysis are known, resulting in fertilization recommendations. The physical properties of the soils are also well studied and analyses guide agricultural management that guarantee the best soil use. On the other hand, although there is a consensus regarding the importance of biological soil properties, there is a limitation in understanding and also in analytical approach that guide the proper management of biological properties in production systems (Lopes et al., 2013; Jansson & Hofmockel, 2018).

It is known that soils, especially those close to plant roots, i.e. the rhizosphere, are colonized by a large biodiversity of living organisms that make up the microbiome, with up to one billion microbial cells per gram of soil, which are closely linked to its functioning, performing essential functions that include nutrient cycling and the structuring of soil aggregates. Additionally, the importance of soil microbiome activity in supplementing plant needs, both nutritionally and to ease biotic and abiotic stresses, is known to keep the production system healthy (Jacoby et al., 2017; Mendes et al., 2013).

In this scenario, agriculture is failed to maintain high levels of diversity and activity of the soil microbiome, and thus most of the soil biodiversity becomes dormant and/or poorly participative in the processes that take place in it. This creates a deficiency in the activity of the soil microbiome, which becomes a limiting factor in the potential of plant production through the use of these resources.

Until now, the search for alternatives to minimize this problem has been based on the use of specific microorganisms, which can act in a specific way, as biodefensives (antagonists to pests and pathogens) or inoculants that promote plant nutrition (making nutrients available). In recent years there has been an impressive increase in the market for biological products in agriculture, but it is important to note that these products mainly consist of one or a few biological agents and neglect the complex microbial community that makes up the soil microbiome (Mendes et al., 2013).

Therefore, the technical solution presented by the present invention allows for a more comprehensive use of the microbiome, that is, the soil and plant-associated microbial resources that normally present themselves as a limiting factor in production systems. The formulation developed has the ability to induce with great efficiency the multiplication of the various microorganisms that are important for the functioning of the soil microbiome, which are effective in supporting plant development. The material developed strategically and complementarily combines a series of substrates uniquely capable of inducing the activities of beneficial members of the soil microbiome and in association with the plant, and is therefore selective and effective in restoring the microbial activity important to the soil-plant system.

The gains from using this additive along with fertilizers result in increased biological activity of the soil microbiome, which is promoted by recovering the functionality of beneficial organisms present in the soil that had potentially been inhibited by degenerative soil use by agriculture. The increased activity of the soil microbiome can be gauged by enzymatic analysis of microbial activity (Lopes et al., 2013). Thus, direct and indirect gains from this greater microbial activity in the soil are expected. The direct response is due to better connectivity between plants and beneficial microorganisms, resulting in conditions where soil diseases are suppressed (Mendes et al., 2011), making the productive system healthier and improving plant rooting. The indirect effects of this increased soil biological activity are through the promotion of improved nutrient cycling, resulting in the activation of biogeochemical cycles in the soil, which include the transformations of nitrogen, phosphorus, and other plant nutrients (Jacoby et al., 2017).

It is important to point out that this biological additive that has been created represents an innovation when compared to other initiatives to add organic materials to the soil fertilization process. In both organic and organomineral fertilizer use, the amounts of organic material employed are very large, ranging from hundreds of kilograms to tons of organic material per hectare. The additive developed here is used in a much smaller dose, from 0.5 to 1% (pp) of the fertilizer volume, and with a maximum dosage of 10 kg per hectare, which enables its use in a wide range of combinations with mineral fertilizers employed in agriculture.

Taken together, the effects of this invention on the soil microbiome lead to a recovery of biological activity, promoting improved productive efficiency of agricultural systems.

### REFERENCES

Jacoby R, Peukert M, Succurro A, Koprivova A, Kopriva S. The Role of Soil Microorganisms in Plant Mineral Nutrition—Current Knowledge and Future Directions. Frontiers in Plant Science 2017. | https://doi.org/10.3389/fpls.2017.01617
Jansson J K, Hofmockel K S. The soil microbiome—from metagenomics to metaphenomics. Current Opinion in Microbiology 2018. | https://doi.org/10.1016/j.mib.2018.01.013
Lopes A C L, Sousa D M G, Chaer G M, Reis Jr F B, Goedert W J, Mendes I C. Interpretation of Microbial Soil Indicators as a Function of Crop Yield and Organic Carbon. Soil Science Society of America Journal 2013. | http://dx.doi.org/10.2136/sssaj2012.0191
Mendes R, Garbeva P, Raaijmakers J M. The rhizosphere microbiome: significance of plant beneficial, plant pathogenic, and human pathogenic microorganisms. FEMS Microbiology Reviews 2013. | https://doi.org/10.1111/1574-6976.12028
Mendes R, Kruijt M, Bruijn Id, Dekkers E, Voort Mvd, Schneider J H M, Piceno Y M, DeSantis T Z, Andersen G L, Bakker P A H M, Raaijmakers J M. Deciphering the rhizosphere microbiome for disease-suppressive bacteria. Science 2011. https://doi.org/10.1126/science.1203980

### SUMMARY OF THE INVENTION

The present invention describes the action of a biological additive, composed of an organic-mineral matrix, capable of being used in combination with mineral fertilizers, and inducing an increased activity of the soil microbiome. The inventors have found a way to explore the properties of the soil microbiome comprehensively, not limited to the use of a single or a few specific microorganisms. The inventors developed a biotechnological formulation that maintains the biochemical properties of the developed material stable when it is combined with mineral fertilizers. This fact allows the soil microbiome to be induced during the fertilizer application process in the management of agricultural systems, resulting in greater productivity. Finally, a great advantage of the biological additive is that it can be used in small doses and combined with different fertilizer formulations for use in all crops.

### BRIEF DESCRIPTION OF THE FIGURES

For a more complete understanding of the invention, reference should now be made to the embodiments of the invention illustrated in greater detail in the accompanying drawings and described by means of the embodiments of the invention.

FIG. 1 illustrates the microcosm used in the experiment.

FIG. 2 illustrates images of the mixtures of the fertilizers evaluated with the different concentrations of Biofer.

FIG. 3 illustrates the corn and soybean planting used for the evaluation of the use of Enzyfert in increasing productivity. A) and B) Independent areas with soybean planting for evaluation in the Limeira/SP region. C) Corn planting Area for the evaluation in the Brotas/SP region.

### DETAILED DESCRIPTION OF THE INVENTION

In describing the embodiments of the invention, the specific terminology is rearranged for clarity. However, it is not intended that the invention be limited to the specific terms so selected, and it should be understood that each specific term includes all equivalent techniques that operate in a similar manner to achieve a similar purpose.

The present invention describes the action of the biological additive developed and named Enzyfert, which presents its physical nature as a solid powder product, and has the following composition:

TABLE 1
Description of the composition of the
biological additive Enzyfert.

| COMPONENT | COMPOSITION (%) |
|---|---|
| Total organic fraction | 89.00 |
| Organic Matter | (37.94) |
| Organic Carbon | (16.24) |
| Other | (51.06) |
| Total mineral fraction | 11.00 |
| Nitrogen | (0.61) |
| Phosphorus | (0.24) |
| Potassium | (0.16) |
| Calcium | (2.04) |
| Magnesium | (0.24) |
| Sulfur | (0.04) |
| Other* | (7.67) |

The detailed chemical analysis of the Enzyfert biological additive as well as the characteristics related to C/N, CTC and CRA are shown in the table below:

TABLE 1
Chemical analysis of the Enzyfert biological additive sample:

| Trials | Result | Unit | LQ | V.M.P. | Method |
|---|---|---|---|---|---|
| Nitrogen | 0.61 | % | — | | Raney's League |
| | | | | | Macromethod |
| Total Phosphorus | 0.24 | % | — | | Chemociac Gravimetric |
| Potassium (HNO3 + | 0.16 | % | — | | Emission Spectrometry |
| HClO4) | | | | | |
| Calcium (HNO3 + | 2.04 | % | — | | Atomic Absorption |
| HClO4) | | | | | Spectrometry |
| Magnesium | 0.24 | % | — | | Atomic Absorption |
| (HNO3 + HClO4) | | | | | Spectrometry |
| Sulfur | 0.04 | % | — | | Barium Sulfate |
| | | | | | Gravimetric |
| Boron | 0.01 | % | — | | Spectrophotometric |
| | | | | | Analysis of Azomethine-H |
| Sodium (HNO3 + | 299.99 | ppm | — | | Emission Spectrometry |
| HClO4) | | | | | |
| Copper (HNO3 + | 34.51 | ppm | — | | Atomic Absorption |
| HClO4 | | | | | Spectrometry |
| Manganese | 0 | ppm | — | | Atomic Absorption |
| (HNO3 + HClO4) | | | | | Spectrometry |
| Iron (HNO3 + | 0.41 | % | — | | Atomic Absorption |
| HClO4) | | | | | Spectrometry |
| Zinc (HNO3 + | 26.31 | ppm | — | | Atomic Absorption |
| HClO4) | | | | | Spectrometry |
| Aluminum (HNO3 + | 2.08 | % | — | | Atomic Absorption |
| HClO4) | | | | | Spectrometry |
| Cobalt (HNO3 + | 11.83 | ppm | — | | Atomic Absorption |
| HClO4) | | | | | Spectrometry |
| Molybdenum | 28.72 | ppm | — | | Atomic Absorption |
| (HNO3 + HClO4) | | | | | Spectrometry |
| Humidity (65° C.) | 18.59 | % | — | | Drying Loss |
| Organic Matter | 37.94 | % | — | | Loss by calcination |
| Organic Carbon | 16.24 | % | 0.44 | | Potassium Dichromate |
| | | | | | Volumetric |
| C/N ratio | 27 | — | — | | Calculation |
| Cation Exchange | 730 | mmolc/kg | — | | Titration |
| Capacity | | | | | |
| Water Retention | 87.41 | % | — | | Gravimetric |
| Capacity | | | | | |
| Ash | 62.06 | % | — | | Calculation |
| Hydrogen | 4.5 | — | — | | pH in CaCl2 |
| Potential (CaCl2) | | | | | |
| Density | 0.85 | g/cm3 | — | | Mass × Volume Ratio |

Enzyfert is composed of the components listed above in a balanced way, and ensures the ability to induce the soil microbiome activity after its mixture with mineral fertilizers.

The production/use process of the biological additive has two steps:

1st STEP—Production of the EnzyFert biological additive: Its production is carried out by Microbiol Ind. e Comércio Ltda, located in Limeira/SP, where the components are dosed and mixed and ground into powder granulometry. They then go through a process of controlled fermentation and stabilization in an anaerobic environment. The product is packed in 25 kg bags and stored on pallets.

2nd STEP—Mixing the Enzyfert biological additive with the mineral fertilizers: Enzyfert is transported to the mineral fertilizer processing industries. At the moment that the different sources of the raw materials that make up the fertilizers are formulated in the mixer, Enzyfert is weighed and added to the mixture. The dose used of Enzyfert is 1% (p.p.) of the fertilizer volume, considering the final mixture of the fertilizer. When the recommendation for agricultural use of the fertilizer is with doses higher than 1,000 kg/ha, a dose of 0.5% (p.p.) of Enzyfert is recommended in the mixture with the fertilizers.

### Efficacy Trials

In one embodiment of the invention, the efficacy of the product was demonstrated using three independent experimental approaches.

The first and second approaches of the invention were performed in the laboratory (microcosms) and the biological activity conferred by the new product was measured by measuring the activity of the enzyme beta-glycosidase, one of the most used as an indicator of soil biological quality (Lopes et al., 2013). This enzyme has a role directly linked to the cycling of carbon in the system, acting specifically at the end of the decomposition of organic compounds, releasing simple sugars, capable of being used by microorganisms as a nutritional source. The tests were conducted for three fertilizer formulations.

In this first approach to the invention an increase in the biological activity of the tested fertilizers by 22.8, 27.0 and 218.2% was found, when the product was mixed with the fertilizers in a proportion of 1%.

### Example 1: Experiment 1—Mixture of EnzyFert Additive with Fertilizers

This study used the fertilizers 10-46-00+9S, 00-00-21+10 Mg+21S and 00-00-58+0.5B for the validation of the EnzyFert additive. For this purpose, the fertilizers targeted for study had EnzyFert added in a proportion of 1% of their masses, and later the activity of enzymes important in nutrient cycling were determined.

Quantifications of enzyme activity are based on the colorimetric determination of p-nitrophenol after incubation of the fertilizer (Experiment 1) or soil (Experiment 2), with a solution buffered with a substrate specific for beta-glycosidase, this being p-nitrophenyl-3-D-glycopyranoside (PNG). The values obtained in the spectrophotometer reading at 410 nm are interpolated to a standard curve with standard p-nitrophenol concentrations, in order to determine the beta-glycosidase activity, expressed as ug PNG.g-1 soil.hour-1.

After preparing the mixtures, the activity of the target enzyme was determined, showing higher values for the mixtures, indicating the potential of the additive to add this characteristic when added to different fertilizers (table 2). The use of the Enzyfert additive increased the enzyme activity quantified in the fertilizers evaluated in the proportions of 22.8, 27.0 and 218.2%, respectively, for fertilizers 10-46-00+9S, 00-00-21+10 Mg+21S and 00-00-58+0.5B.

TABLE 2
Beta-glucosidase activity in samples of fertilizers
isolated or mixed with the
additive EnzyFert at a concentration of 1%.

| | | Fert + | |
|---|---|---|---|
| Fertilizer | Fert | EnzyFert 1% | Increase (%) |
| 10-46-00 + 9S | 3.299 | 4.051 | 22.8 |
| 00-00-21 + 10Mg + | 8.894 | 11.299 | 27.0 |
| 21S | | | |
| 00-00-58 + 0.5B | 4.056 | 12.907 | 218.2 |

In the second approach of the invention, the fertilizers with additives with the new product were added to the soil, and the biological activity was determined by measuring the activity of the enzyme beta-glycosidase. When compared to the treatments that received only the fertilizers, the use of the product provided 5.71, 17.4, and 30.2% increases in enzyme activity for the three fertilizer formulations tested.

### Example 2: Experiment 2—Addition of EnzyFerty and Fertilizer Mixtures to Soil Samples

In this second experiment, the fertilizers, isolated or mixed with EnzyFerty at 1%, were added to soil samples, in order to prove the efficiency of the additive in increasing the activity of these enzymes in the soil. For this experiment the following treatments were prepared:

### 1. Control

2. Fertilizer 10-46-00+9S (200 kg/ha)
3. Fertilizer 00-00-21+10 Mg+21S (430 kg/ha)
4. Fertilizer 00-00-58+0.5B (160 kg/ha)
5. Fertilizer 10-46-00+9S (200 kg/ha)+EnzyFerty 1%

### 6. Fertilizer 00-00-21+10 Mg+21S+EnzyFerty 1%

7. Fertilizer 00-00-58+0.5B (160 kg/ha)+EnzyFerty 1%

The soil samples used were composed of approximately 50 g of soil, previously collected in Piracicaba and currently used as pasture. After assembling all microcosms (FIG. 2), they were kept at room temperature for 5 days, with humidity adjusted to field capacity. After this stabilization period, each treatment was set up in 4 sample repetitions, which received the products in the recommended dosage, as described in the item above.

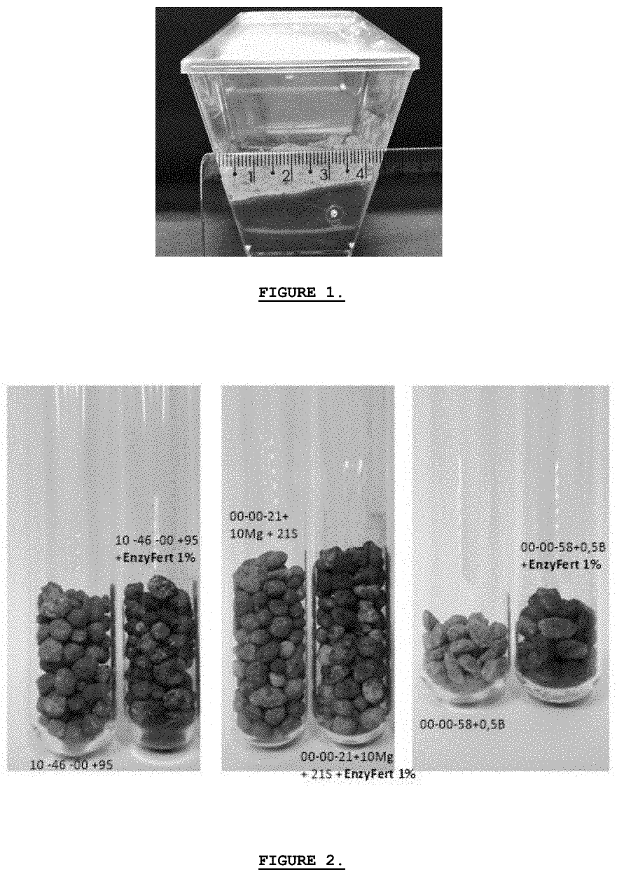

After the addition of the products, the samples were kept at room temperature and evaluated over a period of 8 days, when they were subjected to analyses for beta-glycosidase enzyme activity, as described in Experiment 1. The values obtained for the treatments with the evaluated products and mixtures were compared to those found in the control treatment, which received only water. FIG. 1 is a photo of the container containing soil used in the microcosm experiments and FIG. 2 is a photo of the fertilizers isolated or mixed with Enzyfert evaluated in the experiments.

The experiment conducted by adding the fertilizers, both additive and non-additive, to soil samples confirmed the results of the previous experiment. To facilitate interpretation, the results obtained for each of the fertilizers evaluated are presented below.

Fertilizer 10-46-00+9S. The treatment containing the fertilizer mixture combined with Enzyfert showed the highest value of beta-glucose enzyme activity (table 3). Compared to the treatment with the addition of the fertilizer isolated, the average gain in biological activity in the mixture of fertilizer and EnzyFert was 5.71%, indicated by the beta-glycosity activity.

TABLE 3
Beta-Glycosidase activity in soil samples
from the different treatments with the
fertilizer 10-46-00 + 9S.

| | Beta- |
|---|---|
| Treatment | glycosity activity |
| Control | 72.6 B |
| 10-46-00 + 9S | 77.1 AB |
| 10-46-00 + 9S + EnzyFert 1% | 81.5 A |

*The letters represent the comparison between treatments, in each column, determined by Duncan test (p-value <0.05).

Fertilizer 00-00-21+10 Mg+21S. The treatment containing the fertilizer mixture combined with EnzyFert showed the highest value of beta-glycosidase enzyme activity (table 4). In addition, the treatment with fertilizer isolated showed the lowest value of enzyme activity evaluated. Compared to the treatment with the addition of fertilizer isolated, the average gain in biological activity in the mixture of fertilizer and EnzyFert was 17.4%, indicated by the beta-glycosity activity.

TABLE 4
Beta-glycosidase activity in soil samples from
different treatments with the fertilizer
00-00-21 + 10Mg + 21S.

| | Beta- |
|---|---|
| Treatment | glycosity activity |
| Control | 72.6 B |
| 00-00-21 + 10Mg + 21S | 70.8 B |
| 00-00-21 + 10Mg + 21S + | 83.1 A |
| EnzyFert 1% | |

* The letters represent the comparison between treatments, in each column, determined by Duncan test (p-value <0.05).

Fertilizer 00-00-58+0.5B. The treatment containing the mixture of the fertilizer combined with Biofer showed the highest value of beta-glycosidase activity (table 5). The treatments with Enzyfert isolated or fertilizer isolated also showed a statistical difference. Compared to the treatment with the addition of fertilizer isolated, the average gain in biological activity in the mixture of fertilizer and EnzyFert was 30.2%, indicated by beta-glycosidase activity.

TABLE 5
Beta-glycosidase activity in soil samples from the
different treatments with the fertilizer
00-00-58 + 0.5B.

| | Beta- |
|---|---|
| Treatment | glycosity activity |
| Control | 72.6 B |
| 00-00-58 + 0.5B | 69.8 B |
| 00-00-58 + 0.5B + EnzyFert 1% | 90.9 A |

* The letters represent the comparison between treatments, in each column, determined by Duncan test (p-value <0.05).

Finally, the third experimental approach of the invention was performed under field conditions for two crops, soybean and corn, in two regions, Limeira/SP and Brotas/SP. Different fertilizer formulations were evaluated, combined or not with Enzyfert, that is, the control treatment was always the same fertilizer formulation used to compose the combination with Enzyfert. Standard formulations and dosages recommended according to crop, location, and soil type were used. The use of Enzyfert with fertilizers resulted in a yield increase of 6.78 to 17.10% in the soybean crop and 13.74% in the corn crop.

### Example 3: Experimental Evaluation Under Field Conditions: Enzyfert+Fertilizers

To validate the Enzyfert product under field conditions, different fertilizer formulations were evaluated, combined or not with Enzyfert, that is, the control treatment was always the same fertilizer formulation used to compose the combination with Enzyfert. In the planting of the crops, standard formulations and dosages recommended according to locality, crop and soil type were used standard formulations and dosages recommended according to location, crop, and soil type were used.

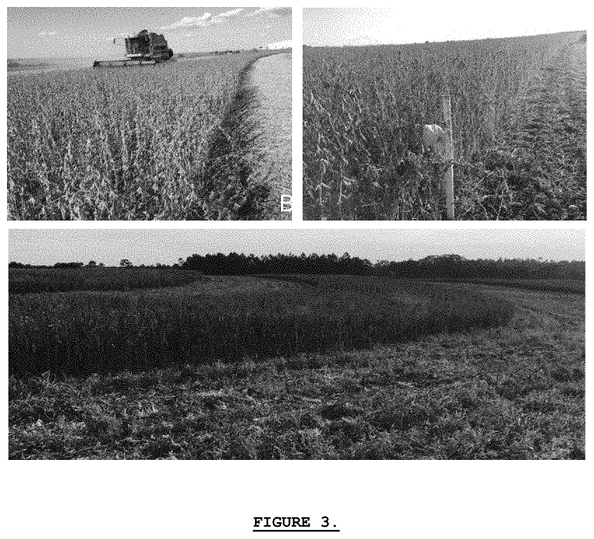

The work was carried out in two different regions as follows:
Region 1 [Limeira/SP]—two soybean plantings were performed in the 2018/19 and 2019/20 crops on Eutrophic Red Latosol soil. In the 2019/20 crop in this region the trial was conducted in two different areas (FIGS. 3A and B; Table 6).
Region 2 [Brotas/SP]—a corn crop was planted in the 2018/19 crop in a Dystrophic Yellow Red Latosol soil (FIG. 3C; Table 6).

TABLE 6
Validation under field conditions showing the increase in soybean and corn
yields with the use of Enzyfert.

| | | | | | | Increased |
|---|---|---|---|---|---|---|
| Culture | | | Area | Application | Yield | productivity |
| and Region | Crop | Treatment | (ha) | (kg/ha) | (sc/ha) | (%) |
| | 2018/19 | NPK 0-40- | 5.7 | 200 | 67.7 | — |
| | | 00 (control) | | | | |
| | | NPK 0-40- | 10.2 | 200 | 73.2 | 8.12% |
| | | 00 + | | | | |
| | | EnzyFert | | | | |
| | | 1% | | | | |
| Soy in | 2019/20 | NPK 0-40- | 5.53 | 220 | 87 | — |
| Limeira/SP | (Area 1) | 00 (control) | | | | |
| | | NPK 0-40- | 4.3 | 220 | 92.9 | 6.78% |
| | | 00 + | | | | |
| | | EnzyFert | | | | |
| | | 1% | | | | |
| | 2019/20 | NPK 0-40- | 12.25 | 220 | 77.2 | — |
| | (Area 2) | 00 (control) | | | | |
| | | NPK 0-40- | 4.6 | 220 | 90.4 | 17.10% |
| | | 00 + | | | | |
| | | Enzyfert | | | | |
| | | 1% | | | | |
| Corn in | 2018/19 | NPK 20-10- | 1.82 | 200 | 83.7 | — |
| Brota SP | | 10 (control) | | | | |
| | | NPK 20-10- | 1.6 | 200 | 95.2 | 13.74% |
| | | 10 + | | | | |
| | | Enzyfert | | | | |
| | | 1% | | | | |

In conclusion, the use of the new product in a mixture at a proportion of 1% with mineral fertilizers, was able to: 1) increase the biological activity of the fertilizer; 2) increase the biological activity of the soil compared to the use of the fertilizer isolated; 3) increase crop productivity under field production system conditions when compared to the use of the fertilizer without the addition of the new product.

1. Use of an additive that induces the microbial activity of the soil, CHARACTERIZED for being used in small doses of 0.5% or 1% in combination with mineral fertilizers, to induce the biological activity of the soil and the rhizosphere.

2. Use of soil microbial activity inducing additive according to claim 1, CHARACTERIZED by being applied in inducing the soil and rhizosphere microbiome in a comprehensive manner, i.e., not limited to the action of a single or few specific microorganisms.

3. Use of an additive inducing soil microbial activity according to claim 1, CHARACTERIZED by the fact that the additive maintains biochemical properties when combined with mineral fertilizers, and wherein its effect in stimulating the activity of the soil microbiome or rhizosphere can be verified using indicators of microbial enzyme activity.

4. Production process of an additive inducing the microbial activity of the soil, CHARACTERIZED by being constituted by two steps:
(i) in the first stage, the components are dosed, mixed, crushed and undergo a controlled fermentation process in an anaerobic environment
(ii) in the second stage, the formulation is prepared with fertilizers in dosages of 0.5% or 1%
